(19) United States
(12) Patent Application Publication
(10) Pub. No.: US 2015/0106656 A1
(43) Pub. Date: Apr. 16, 2015

(54) APPLICATION PROGRAM STARTUP METHOD AND APPARATUS

(71) Applicant: Tencent Technology (Shenzhen) Company Limited, Shenzhen, Guangdong (CN)

(72) Inventors: Chao Bian, Beijing (CN); Wenhuan Zhu, Beijing (CN)

(21) Appl. No.: 14/383,763

(22) PCT Filed: Mar. 4, 2013
(86) PCT No.: PCT/CN2013/072145

§ 371 Date: Sep. 8, 2014

(30) Foreign Application Priority Data
Mar. 14, 2012 (CN) 201210067122.3

(51) Int. Cl. G06F 11/07

(52) U.S. Cl. CPC G06F 11/079; G06F 11/0721
USPC 714/37

(57) ABSTRACT

The present invention, pertaining to the field of computer technologies, discloses an application startup method and apparatus. The method includes: loading, upon receiving an instruction for starting up an application program, prefetch data corresponding to the application program, where the prefetch data includes at least one file block corresponding to at least one page fault occurred during a history startup process of the application program; and loading code of the application program to start up the application program. The apparatus includes: a prefetch data loading module and a code loading module. According to the present invention, the number of page faults occurred during the startup process of the application program because a process cannot be mapped to a valid physical page when accessing a virtual page is greatly reduced. Further, since before the code of the application program is loaded, instead of all file blocks during the initial startup of the application program, only the file block(s) corresponding to page fault(s) is loaded, frequent memory page flipping and file flipping during the loading process of the application program are mitigated, and startup speed and startup efficiency of the application program are improved.

### TECHNICAL FIELD

The present invention relates to the field of computer technologies, and in particular, to an application program startup method and apparatus.

### BACKGROUND

With the rapid development of computer technologies, users may install various types of application programs. An application program needs to be started up to use the functions thereof.

The startup process of an application program can be implemented by loading code of the application program by a process. During the loading of the code, the process needs to access a virtual page. When the accessed virtual page is mapped to a valid physical page in the physical memory, the process loads the corresponding file blocks of the physical page; whereas when the accessed virtual page is not mapped to a valid physical page in the physical memory, but is mapped to a physical page in another state in the physical memory, a soft fault occurs, and the process needs to load the corresponding file blocks from the physical memory. Further, when the accessed virtual page is neither mapped to a valid physical page in the physical memory nor mapped to a physical page in another state in the physical memory, a hard fault occurs, and the process needs to load the corresponding file blocks from a disk file.

When a soft fault or a hard fault occurs, the process needs to load file blocks from different positions in the physical memory and disk file. Therefore, during the loading of the file blocks by the process, read/write positions of the magnetic head during disk read/write (I/O) are noncontiguous, causing flipping of the magnetic head on the disk. Consequently, the speed of each loading is greatly slowed and thus startup speed of the application program is slowed. Further, disk read/write in the case of a hard fault is conducted on a on-demand basis, and the data corresponding to a hard fault is only read in each disk read/write, with a smaller disk read-write size (16 KB of a data page and 32 KB of a code page), which is far smaller than the disk read/write capability of conducting one disk read/write. Accordingly, the disk read/write capability is not brought into full play. Consequently, disk read/write efficiency in the case of a hard fault is low, and thus startup efficiency of the application program is low.

### SUMMARY

To improve the startup speed of an application program, embodiments of the present invention provide an application program startup method and apparatus. The technical solutions are as follows:

An embodiment of the present invention provides an application program startup method, where the method includes:

loading, upon receiving an instruction for starting up an application program, prefetch data corresponding to the application program, where the prefetch data includes at least one file block corresponding to at least one page fault occurred during a history startup process of the application program; and

loading code of the application program to start up the application program.

Prior to loading, upon receiving an instruction for starting up an application program, prefetch data corresponding to the application program, the method further includes:

analyzing the history startup process of the application program to obtain the prefetch data corresponding to the application program during the history startup process.

The analyzing the history startup process of the application program to obtain the prefetch data corresponding to the application program during the history startup process specifically includes:

obtaining at least one mapped file list loaded and the virtual address of the at least one page fault occurred during the history startup process of the application program;

calculating the file offset corresponding to each virtual address according to the at least one mapped file list and the at least one virtual address; and

combining, according to the file offset corresponding to each virtual address, file blocks corresponding to the file offset corresponding to the at least one virtual address to obtain the prefetch data corresponding to the application program.

The obtaining at least one mapped file list loaded and the virtual address of the at least one page fault occurred during the history startup process of the application program specifically includes:

obtaining at least one log file of the application program;

determining a time segment in the at least one log file from a startup time of a user interface process to a foreground window display time as a predetermined startup time segment;

obtaining the mapped file list loaded by a process during the predetermined startup time segment in the at least one log file; and

obtaining the virtual address of the at least one page fault occurred during the predetermined startup time segment.

The combining, according to the file offset corresponding to each virtual address, file blocks corresponding to the file offset corresponding to the at least one virtual address to obtain the prefetch data corresponding to the application program specifically includes:

combining, according to the file offset corresponding to each virtual address, file blocks with spacing between the file offsets corresponding to the at least one virtual address being smaller than a predetermined number of bits to obtain the prefetch data corresponding to the application program.

An embodiment of the present invention provides an application program startup apparatus, where the apparatus includes:

a prefetch data loading module, configured to load, upon receiving an instruction for starting up an application program, prefetch data corresponding to the application program, where the prefetch data includes at least one file block corresponding to at least one page fault occurred during a history startup process of the application program; and

a code loading module, configured to load code of the application program to start up the application program.

The apparatus further includes:

a prefetch data obtaining module, configured to analyze the history startup process of the application program to obtain the prefetch data corresponding to the application program during the history startup process.

The prefetch data obtaining module includes:

an obtaining unit, configured to obtain at least mapped file list loaded and the virtual address of the at least one page fault occurred during the history startup process of the application program;

an offset calculating unit, configured to calculate the file offset corresponding to each virtual address according to the at least one mapped file list and the at least one virtual address; and

a prefetch data obtaining unit, configured to combine, according to the file offset corresponding to each virtual address, file blocks corresponding to the file offset corresponding to the at least one virtual address to obtain the prefetch data corresponding to the application program.

The obtaining unit includes:

a log obtaining subunit, configured to obtain at least one log file of the application program;

a time segment determining subunit, configured to determine a time segment in the at least one log file from a startup time of a user interface process to a foreground window display time as a predetermined startup time segment;

a mapped file list obtaining subunit, configured to obtain the mapped file list loaded by a process during the predetermined startup time segment in the at least one log file; and

a virtual address obtaining subunit, configured to obtain the virtual address of the at least one page fault occurred during the predetermined startup time segment.

The prefetch data obtaining unit is specifically configured to combine, according to the file offset corresponding to each virtual address, file blocks between the file offsets corresponding to the at least one virtual address with spacing being smaller than a predetermined number of bits to obtain the prefetch data corresponding to the application program.

The technical solutions provided in the embodiments of the present invention achieve the following beneficial effects:

During startup of an application program, by firstly loading at least one file block corresponding to at least one page fault occurred during a history startup process of the application program and then loading code of the application program, the number of page faults occurred during the startup process of the application program because a process cannot be mapped to a valid physical page when accessing a virtual page is greatly reduced since the prefect data includes the file block(s) corresponding to the page fault(s) occurred during the history startup process of the application program. Further, since before the code of the application program is loaded, instead of all file blocks during the initial startup of the application program, only the file block(s) corresponding to page fault(s) is loaded, frequent memory page flipping and file flipping during the loading process of the application program are mitigated, and startup speed and startup efficiency of the application program are improved.

### BRIEF DESCRIPTION OF THE DRAWINGS

For a better understanding of the technical solutions in the embodiments of the present invention, the accompanying drawings for illustrating the embodiments are briefly described below. Apparently, the accompanying drawings in the following description illustrate only some embodiments of the present invention, and a person skilled in the art may derive other accompanying drawings from these accompanying drawings without any creative efforts.

FIG. 1 is a flowchart of an application program startup method according to an embodiment of the present invention;

FIG. 2 is a flowchart of an application program startup method according to an embodiment of the present invention;

FIG. 3 is a schematic diagram of comparison between a startup time of an application program in the prior art and a startup time using a application program startup method according to embodiments of the present invention; and

FIG. 4 is a schematic structural diagram of an application program startup apparatus according to an embodiment of the present invention.

### DETAILED DESCRIPTION

To make the objectives, technical solutions, and advantages of the present invention clearer, the following describes the embodiments of the present invention in detail below with reference to the accompanying drawings.

Before the description of an application program startup method and apparatus provided in the embodiments of the present invention, the following firstly defines key terms involved in the present invention are defined as follows.

Page fault: includes soft fault and hard fault.

Mapped file: A file in the magnetic disk is mapped to a virtual address space and the file is accessed in the same manner as a memory is accessed. The mapped file is referred to as a mapped file. During startup of a process, EXE and DLL files are loaded by using the mapped file.

Disk I/O: Disk read and write.

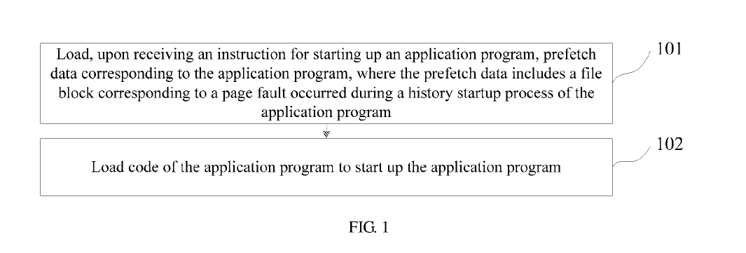

FIG. 1 is a flowchart of an application program startup method according to an embodiment of the present invention. Referring to FIG. 1, this embodiment includes:

101. loading, upon receiving an instruction for starting up an application program, prefetch data corresponding to the application program, where the prefetch data includes at least one file block corresponding to at least one page fault occurred during a history startup process of the application program; and

102. loading code of the application program to start up the application program.

Alternatively, prior to loading, upon receiving an instruction for starting up an application program, prefetch data corresponding to the application program, the method further includes:

analyzing the history startup process of the application program to obtain the prefetch data corresponding to the application program during the history startup process.

Alternatively, the analyzing the history startup process of the application program to obtain the prefetch data corresponding to the application program during the history startup process specifically includes:

obtaining at least one mapped file list loaded and the virtual address of the at least one page fault occurred during the history startup process of the application program;

calculating the file offset corresponding to each virtual address according to the at least one mapped file list and the at least one virtual address; and

combining, according to the file offset corresponding to each virtual address, file blocks corresponding to the file offset corresponding to the at least one virtual address to obtain the prefetch data corresponding to the application program.

Alternatively, the obtaining at least one mapped file list loaded and the virtual address of the at least one page fault occurred during the history startup process of the application program specifically includes:

obtaining at least one log file of the application program;

determining a time segment in the at least one log file from a startup time of a user interface process to a foreground window display time as a predetermined startup time segment;

obtaining the mapped file list loaded by a process during the predetermined startup time segment in the at least one log file; and

obtaining the virtual address of the at least one page fault occurred during the predetermined startup time segment.

Alternatively, the combining, according to the file offset corresponding to the each virtual address, file blocks corresponding to the file offset corresponding to the at least one virtual address to obtain the prefetch data corresponding to the application program specifically includes:

combining, according to the file offset corresponding to each virtual address, file blocks with spacing between file offsets corresponding to the at least one virtual address being smaller than a predetermined number of bits to obtain the prefetch data corresponding to the application program.

According to the method provided in this embodiment, during startup of an application program, by firstly loading at least one file block corresponding to at least one page fault occurred during a history startup process of the application program and then loading code of the application program, the number of page faults occurred during the startup process of the application program because a process cannot be mapped to a valid physical page when accessing a virtual page is greatly reduced since the prefect data includes the file block(s) corresponding to the page fault(s) occurred during the history startup process of the application program. Further, since before the code of the application program is loaded, instead of all file blocks during the initial startup of the application program, only the file block(s) corresponding to page fault(s) is loaded, startup speed and startup efficiency of the application program are improved.

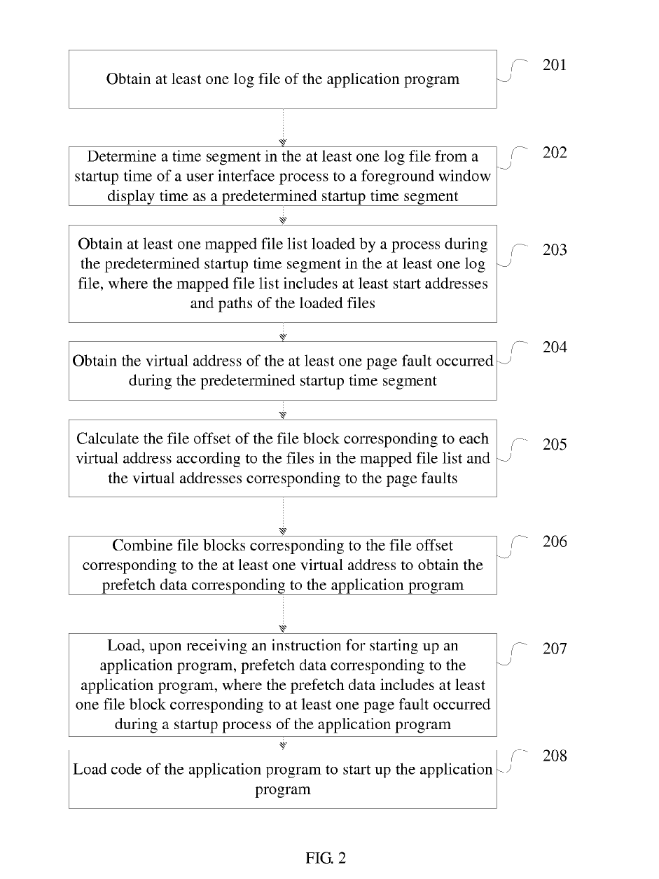

FIG. 2 is a flowchart of an application program startup method according to an embodiment of the present invention. The execution body of this embodiment is a terminal. The terminal may be a personal computer (PC) or a mobile terminal. The mobile terminal may be a smart phone, a tablet computer, a moving picture experts group audio layer III (MP3), a personal digital assistant (PDA), or the like. Referring to FIG. 2, this embodiment specifically includes:

201. obtaining at least one log file of the application program.

A log file is a file containing system-related messages. Different log files record different information. For example, some log files are used to record default system operations, whereas some are used to record security information only. In step 201, the obtained log file of the application program is used to record information related to startup and running of the application program. The log file at least includes the startup information of the application program, where the startup information includes information of page fault occurred during a history startup process of an application program.

The log file obtained in step 201 may be based on event tracing for Windows (ETW). ETW is a uniform mechanism for event tracing and recording provided by Windows. A user-mode application program and a kernel-mode driver can both record events using ETW.

It should be noted that, in step 201, at least one log file is obtained, where the at least one log file respectively corresponds to the startup information of at least one startup process of an application program.

202. determining a time segment in the at least one log file from a startup time of a user interface process to a foreground window display time as a predetermined startup time segment.

The startup time of a user interface process may be understood as the startup time of the application program whereas the foreground window display time may be understood as the time for loading the code of the application program. In this embodiment, description is given only using determining the time segment in the at least one log file from the startup time of a user interface process to the foreground window display time as the predetermined startup time segment as an example. The predetermined startup time segment may also be shortened to a smaller range, which may be specifically set by a person skilled in the art and is thus not further defined in this embodiment.

203. obtaining at least one mapped file list loaded by a process during the predetermined startup time segment in the at least one log file, where the mapped file list includes at least start addresses and paths of the loaded files.

A mapped file list is a list of files loaded by the process during the predetermined startup time segment of the application programs and recorded in the log file. The mapped file list includes at least the start addresses and paths of the loaded files. For the application program, the files in the mapped file list are loaded due to the page fault occurred during a startup process of the application program. Therefore, after the mapped file list is obtained, it can be known that which files have been loaded when the page fault occurred during the startup process of the application program, and the specific paths of the loaded files.

It should be noted that, the mapped file list loaded by a process during a predetermined startup time segment in each log file can be obtained while considering files loaded by the process during a plurality of startup processes of an application program such that the subsequent combination and loading prevent page faults from occurring during the startup of the application program at the maximum.

204. obtaining the virtual address of the at least one page fault occurred during the predetermined startup time segment.

The virtual address is an address of the virtual page accessed by a process during the startup process of the application program. In step 204, after the virtual address of the page fault occurred in a process during the predetermined startup time segment is obtained, it can be known which virtual addresses are not mapped to valid physical addresses during the startup process of the application program.

It should be noted that, because the page faults occurred during a plurality of startup processes of an application program are not exactly the same, the plurality of startup processes of the application program need to be analyzed to obtain the mapped file list loaded by a process and the virtual address when the page fault occurs. In steps 201-204 of this embodiment, the process of analyzing only a log file of a single startup and obtaining a mapped file list and a virtual address when a page fault occurs is used as an example for detailed description. In practice, a plurality of log files may be analyzed simultaneously and the mapped file list and the virtual address when a page fault occurs may be obtained; or the plurality of log files is sequentially analyzed and the mapped file list and the virtual address when the page fault occurs can be obtained. The plurality of log files may be analyzed in multiple sequences, which may be specifically set by a person skilled in the art and is not defined in this embodiment.

205. calculating the file offset of the file block corresponding to each virtual address according to the files in the mapped file list and the virtual addresses corresponding to the page faults.

A person skilled in the art may learn that, for a single mapped file in a mapped file list, a relative virtual address is obtained by subtracting the virtual address when a page fault occurs from the start address of the mapped file, and the file offset of the file block is obtained by using the relative virtual address. The relative virtual address is in piecewise linear relationship with the file offset, and the piecewise linear relationship is set according to the mapped file (PE file format), which is not detailed here any further.

206. combining, according to the file offset corresponding to each virtual address, file blocks corresponding to the file offset corresponding to the at least one virtual address to obtain the prefetch data corresponding to the application program.

Specifically, according to the file offset corresponding to each virtual address, file blocks corresponding to the file offset corresponding to each of the at least one virtual address are combined to obtain the prefetch data corresponding to the application program.

Preferably, according to the file offset corresponding to each virtual address, file blocks with spacing between file offsets corresponding to the at least one virtual address being smaller than a predetermined number of bits are combined to obtain the prefetch data corresponding to the application program.

Preferably, the predetermined number of bits may be 64 KB. If the spacing between two file blocks is smaller than 64 KB, these two file blocks are combined. The corresponding prefetch data is obtained by combining a plurality of file blocks. The predetermined number of bits may be any of other values, which may be set by a person skilled in the art.

A person skilled in the art learns that the disk read/write caused by a hard fault reads only the data corresponding to the hard fault, with the size of only 16 KB or 32 KB, which is far smaller than the disk read/write capability of conducting one disk read/write. For example, the size of one disk read/write reaches 2 MB Windows 7, and reaches 1 MB on Windows XP. Accordingly, the disk read/write capability is not brought into full play, thereby greatly reducing disk read/write efficiency. Therefore, in this embodiment, adjacent file blocks are combined so that the subsequent loading of the prefetch data can be implemented by using a limited number of times of disk read/write. In this way, disk read/write efficiency during the startup process of the application program is greatly improved by loading the prefetch data before the code of the application program is loaded, that is, startup speed and efficiency of the application program are improved.

Table 1 is an example of file blocks in a module combined during the startup process of an application program.

TABLE 1

| Range of | Size | Number | Segment of |
|---|---|---|---|
| File Offset | (KB) | of Pages | File Block |
| [400, 1183FF] | 6964 | 1741 | .text |
| [873400, 8F03FF] | 500 | 125 | .text |
| [915400, 92C3FF] | 92 | 23 | .text |
| [954400, 9F73FF] | 652 | 163 | .text |
| [A8AC00, BF6BFF] | 1456 | 364 | .rdata |

In Table 1, the range of file offset refers to a file offset range of file blocks before combination, the size refers to the size of combined file block, the number of pages refers to the number of combined pages, and the segment of the file refers to the segment to which the file belongs. It can be seen from Table 1 that for files belonging to different segments, the size of the combined file block (the size of one disc read/write) is far greater than the disk read/write size (16 KB or 32 KB) each time a page fault occurs before file block combination. For example, as for pages in a file offset range of [400, 1183FF], 1741 pages can be combined into 6964 KB data. In this way, the subsequent loading of the prefetch data can be completed by only one disk read/write, which, as compared against the original 1741 times of disk read/write, greatly improves disk read/write efficiency.

Preferably, the process of obtaining the prefetch data in steps 201-206 may be performed when the system is idle or the application program is not started up. This effectively utilizes system efficiency without affecting the running of other application programs in the system.

207: loading, upon receiving an instruction for starting up an application program, prefetch data corresponding to the application program, where the prefetch data includes at least one file block corresponding to at least one page fault occurred during a startup process of the application program.

Through the loading in step 207, the file blocks in the prefetch data are all loaded by the process into the physical memory. When an instruction for starting up an application program is received, prefetch data corresponding to the application program is loaded before the application program runs other code, and then step 208 is performed; when the application program actually visits these pages, the page fault, especially the time consuming hard fault, will not occur, thereby improving the startup speed.

Preferably, the prefetch data may be stored in a DB file; when the instruction for starting up the application is received, the DB file is read to load the prefetch data corresponding to the application program.

208: loading code of the application program to start up the application program.

A person skilled in the art may know that step 208 is similar to the loading method in the prior art, which is not detailed here any further.

During the process of loading the code of the application program in step 208, the process accesses a virtual page; when the accessed virtual page is mapped to a valid physical page in the physical memory, the process loads corresponding file blocks corresponding to the physical page. Since all file blocks corresponding to the page fault occurred during the history startup process of the application program, no page fault will occur during the loading of the code of the application program. Therefore, the number of page faults occurred during the startup process of the application program because a process cannot be mapped to a valid physical page when accessing a virtual page is greatly reduced, and disk read/write efficiency is greatly improved by consuming a small amount of redundant data.

This embodiment differs from the prior art in that: by loading the prefetch data before the code of the application program is loaded, the number of the page faults occurred during the startup process of the application program because a process cannot be mapped to a valid physical page when accessing a virtual page is greatly reduced since the prefetch data includes the file block(s) corresponding to the page fault(s) occurred during the history startup process of the application program. In this way, startup speed and startup efficiency of the application program are improved.

This embodiment further differs from the prior art in that: before the code of the application program is loaded, instead of all file blocks during the initial startup of the application program, only the file block(s) corresponding to page fault(s) is loaded, This refines the loading granularity. By loading the prefetch data before the code of the application program is loaded, the number of the page faults occurred during the startup process of the application program because a process cannot be mapped to a valid physical page when accessing a virtual page is greatly reduced since the prefect data includes the file block(s) corresponding to the page fault(s) occurred during the history startup process of the application program. In this way, frequent memory page flipping and file flipping during the loading process of the application program are mitigated, and startup speed and startup efficiency of the application program are improved.

It should be noted that the application program startup method provided in this embodiment is applicable to any application program, and requires no modification of existing code. The process for obtaining the prefetch data in steps 201-206 in this embodiment is not limited to the startup process of an application program, and is also applicable to any scenario of improving the performance of an application program.

Preferably, after steps 207-208 are performed, the application program is started up, and =on the startup process of the application program can be tested to determine the effects created by firstly loading the prefetch data and then loading the code of the application program. Because a hard fault occurred during the startup process of the application program is the most time consuming, the number of hard faults occurred during the startup process of the application program is detected. If the number of hard faults is reduced or the hard faults disappear compared with those in the history startup process, the prefetch data obtained through steps 201-206 includes most pages to be accessed by the application program. Table 2 is a comparison between the number of hard faults occurred in a main module on Windows 7 and that on Windows XP during the startup process of an application program. It can be seen that the number of occurrences of hard faults is greatly reduced or the hard faults disappear after the technical solutions of the present invention are used.

TABLE 2

| | Number of hard faults | Number of hard faults |
|---|---|---|
| | on Windows 7 | on Windows XP |
| Before prefetching | 423 | 330 |
| After prefetching | 35 | 0 |

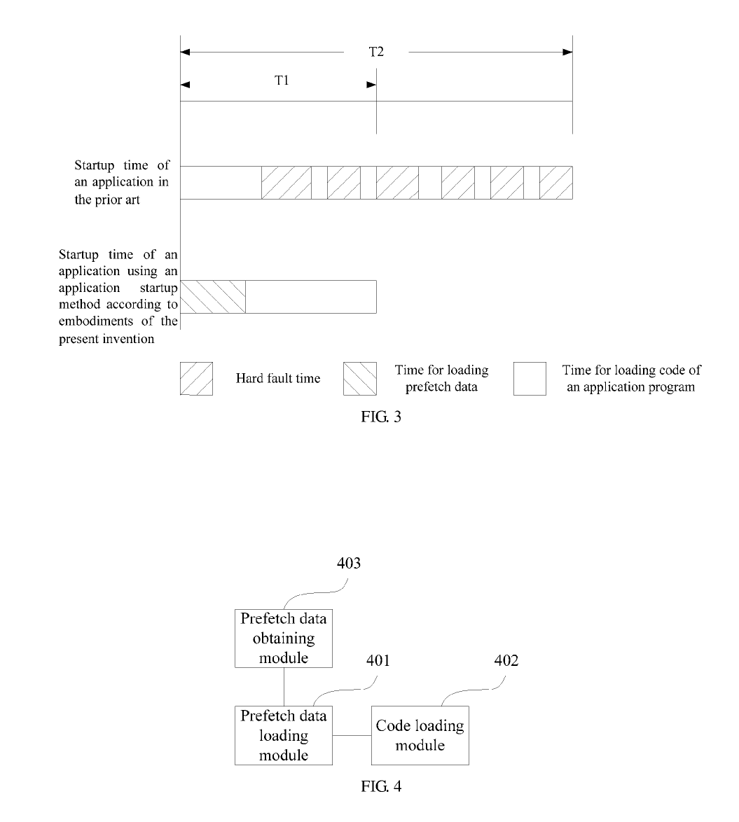

FIG. 3 is a schematic diagram of comparison between a startup time of an application program in the prior art and a startup time using an application program startup method according to the embodiments of the present invention. Referring to FIG. 3, the startup time T2 of an application program in the prior art includes hard fault time and time for loading code of the application program, the startup time T1 according to the application program startup method provided in the embodiments of the present invention includes time for loading prefetch data and time for loading code of the application program. T1 is far smaller than T2. The startup time according to the application program startup method provided in the embodiments of the present invention does not include the hard fault time, thereby greatly improving the startup speed.

According to the method provided in this embodiment, during startup of an application program, by firstly loading at least one file block corresponding to at least one page fault occurred during a history startup process of the application program and then loading code of the application program, the number of page faults occurred during the startup process of the application program because a process cannot be mapped to a valid physical page when accessing a virtual page is greatly reduced since the prefect data includes the file block(s) corresponding to the page fault(s) occurred during the history startup process of the application program. Further, since before the code of the application program is loaded, instead of all file blocks during the initial startup of the application program, only the file block(s) corresponding to page fault(s) is loaded, frequent memory page flipping and file flipping during the loading process of the application program are mitigated, and startup speed and startup efficiency of the application program are improved. Further, by combining adjacent file blocks, disk read/write efficiency is greatly enhanced.

To further describe the beneficial effects of the present invention, the following gives detailed description with reference to the comparison between the application program startup process in the prior art and the startup process using the application program startup method according to the embodiments of the present invention.

Table 3 is a comparison between disk read/write parameters in a main module during the startup process of an application program in the prior art and those during the startup process using an application program startup method according to the embodiments of the present invention.

TABLE 3

| | Disk | Number of | Disk |
|---|---|---|---|
| | Read/Write | Times of Disk | Read/Write |
| | Size (MB) | Read/Write | Time (ms) |
| Prior art | 8.46 | 387 | 2013 |
| Solution of the | 12.094 | 54 | 207 |
| present invention | | | |

It can be learned from the comparison between the parameters in Table 3 that, after the technical solutions of the present invention are used, the time consumed by disk read/write in a main module of the application program is reduced from 2013 ms to about 207 ms, the size of disk read/write is increased from 8 MB to 12 MB, and the number of times of disk read/write is reduced from 387 to 54. Accordingly, the disk read/write size is increased by obtaining the prefetch data through combining the file blocks, firstly loading the prefect data during startup of the application program and then loading code of the application program. However, the number of times of disk read/write and the disk read/write time are reduced, thereby reducing the total disk read/write time during the startup process of the application program.

Table 4 is a comparison between a startup time of an application program in the prior art and a startup time using an application program startup method according to embodiments of the present invention.

TABLE 4

| | Time (seconds) Required | Time (seconds) Required |
|---|---|---|
| | for Startup of an Appli- | for Startup of an Appli- |
| | cation on Windows XP | cation on Windows 7 |
| Prior art | 5.28 | 6.43 |
| Solution of the | 2.38 | 3.69 |
| present invention | | |

To reduce interference, the startup time refers to the startup time in a scenario where other optimization techniques are not used. It can be learned from Table 4 that, after the technical solutions of the present invention are used, on different operating systems, the startup time of an application program is reduced by 50%-60% as compared with the startup time according to the prior art. For example, as compared with the prior art, the startup time of an application program is reduced from 5.28 s to 2.38 s on a Windows XP environment, and is reduced from 6.43 s to 3.69 s on a Windows 7 environment.

FIG. 4 is a schematic structural diagram of an application program startup apparatus according to an embodiment of the present invention. Referring to FIG. 4, the apparatus includes:

a prefetch data loading module 401, configured to load, upon receiving an instruction for starting up an application program, prefetch data corresponding to the application program, where the prefetch data includes at least one file block corresponding to at least one page fault occurred during a history startup process of the application program; Preferably, the prefetch data may be stored in a DB file; when the instruction for starting up the application is received, the DB file is read to load the prefetch data corresponding to the application program. and

a code loading module 402, configured to load code of the application program to start up the application program.

The apparatus further includes:

a prefetch data obtaining module 403, configured to analyze the history startup process of the application program to obtain the prefetch data corresponding to the application program during the history startup process.

The prefetch data obtaining module 403 includes:

an obtaining unit, configured to obtain at least one mapped file list loaded and the virtual address of the at least one page fault occurred during the history startup process of the application program;

an offset calculating unit, configured to calculate the file offset corresponding to each virtual address according to the at least one mapped file list and the at least one virtual address; A person skilled in the art may learn that, for a single mapped file in a mapped file list, a relative virtual address is obtained by subtracting the virtual address when a page fault occurs from the start address of the mapped file, and the file offset of the file block is obtained by using the relative virtual address. The relative virtual address is in piecewise linear relationship with the file offset, and the piecewise linear relationship is set according to the mapped file (PE file format), which is not detailed here any further. and

a prefetch data obtaining unit, configured to combine, according to the file offset corresponding to each virtual address, file blocks corresponding to the file offset corresponding to the at least one virtual address to obtain the prefetch data corresponding to the application program.

The obtaining unit includes:

a log obtaining subunit, configured to obtain at least one log file of the application program. the obtained log file of the application program is used to record information related to startup and running of the application program. The log file at least includes the startup information of the application program, where the startup information includes information of page fault occurred during a history startup process of an application program.

a time segment determining subunit, configured to determine a time segment in the at least one log file from a startup time of a user interface process to a foreground window display time as a predetermined startup time segment. The startup time of a user interface process may be understood as the startup time of the application program whereas the foreground window display time may be understood as the time for loading the code of the application program. In this embodiment, description is given only using determining the time segment in the at least one log file from the startup time of a user interface process to the foreground window display time as the predetermined startup time segment as an example. The predetermined startup time segment may also be shortened to a smaller range, which may be specifically set by a person skilled in the art and is thus not further defined in this embodiment.

a mapped file list obtaining subunit, configured to obtain a mapped file list loaded by a process during the predetermined startup time segment in the at least one log file. A mapped file list is a list of files loaded by the process during the predetermined startup time segment of the application programs and recorded in the log file. The mapped file list includes at least the start addresses and paths of the loaded files. For the application program, the files in the mapped file list are loaded due to the page fault occurred during a startup process of the application program. Therefore, after the mapped file list is obtained, it can be known that which files have been loaded when the page fault occurred during the startup process of the application program, and the specific paths of the loaded files. It should be noted that, the mapped file list loaded by a process during a predetermined startup time segment in each log file can be obtained while considering files loaded by the process during a plurality of startup processes of an application program such that the subsequent combination and loading prevent page faults from occurring during the startup of the application program at the maximum. and

a virtual address obtaining subunit, configured to obtain the virtual address of the at least one page fault occurred during the predetermined startup time segment. The virtual address is an address of the virtual page accessed by a process during the startup process of the application program. After the virtual address of the page fault occurred in a process during the predetermined startup time segment is obtained, it can be known which virtual addresses are not mapped to valid physical addresses during the startup process of the application program.

It should be noted that, because the page faults occurred during a plurality of startup processes of an application program are not exactly the same, the plurality of startup processes of the application program need to be analyzed to obtain the mapped file list loaded by a process and the virtual address when the page fault occurs.

Preferably, The prefetch data obtaining unit is specifically configured to combine, according to the file offset corresponding to each virtual address, file blocks with spacing between file offsets corresponding to the at least one virtual address being smaller than a predetermined number of bits to obtain the prefetch data corresponding to the application program. Preferably, the predetermined number of bits may be 64 KB. If the spacing between two file blocks is smaller than 64 KB, these two file blocks are combined. The corresponding prefetch data is obtained by combining a plurality of file blocks. The predetermined number of bits may be any of other values, which may be set by a person skilled in the art.

According to the apparatus provided in this embodiment, during startup of an application program, by firstly loading at least one file block corresponding to at least one page fault occurred during a history startup process of the application program and then loading code of the application program, the number of page faults occurred during the startup process of the application program because a process cannot be mapped to a valid physical page when accessing a virtual page is greatly reduced since the prefect data includes the file block(s) corresponding to the page fault(s) occurred during the history startup process of the application program. Further, since before the code of the application program is loaded, instead of all file blocks during the initial startup of the application program, only the file block(s) corresponding to page fault(s) is loaded, startup speed and startup efficiency of the application program are improved.

It should be noted that, during application program startup, the application program startup apparatus according to the above embodiments only is described by only using division of the above functional modules for description. In practice, the functions may be assigned to different functional modules for implementation as required. To be specific, the internal structure of the apparatus is divided into different functional modules to implement all or part of the above-described functions. In addition, the application program startup apparatus and the application program startup method pertains to the same concept, where the specific implementation is elaborated in the method embodiments, which is not be detailed herein any further.

A person skilled in the art should understand that all or part steps of the preceding methods may be implemented by hardware or hardware following instructions of programs. The programs may be stored in a computer readable storage medium. The storage medium may be a read only memory, a magnetic disk, or a CD-ROM.

An application program startup device according to an embodiment of the present invention. the device is used for the application program startup method, where the device includes:

memory, and

one or more processors,

the one or more processors are configured to perform functions as follows:

loading, upon receiving an instruction for starting up an application program, prefetch data corresponding to the application program, wherein the prefetch data comprises at least one file block corresponding to at least one page fault occurred during a history startup process of the application program; and

loading code of the application program to start up the application program.

Preferably, the one or more processors are further configured to perform functions as follows:

analyzing the history startup process of the application program to obtain the prefetch data corresponding to the application program during the history startup process.

Preferably, the one or more processors are further configured to perform functions as follows:

obtaining at least one mapped file list loaded and the virtual address of the at least one page fault occurred during the history startup process of the application program;

calculating the file offset corresponding to each virtual address according to the at least one mapped file list and the at least one virtual address; and

combining, according to the file offset corresponding to each virtual address, file blocks corresponding to the file offset corresponding to the at least one virtual address to obtain the prefetch data corresponding to the application program.

Preferably, the one or more processors are further configured to perform functions as follows:

obtaining at least one log file of the application program;

determining a time segment in the at least one log file from a startup time of a user interface process to a foreground window display time as a predetermined startup time segment;

obtaining the mapped file list loaded by a process during the predetermined startup time segment in the at least one log file; and

obtaining the virtual address of the at least one page fault occurred during the predetermined startup time segment.

Preferably, the one or more processors are further configured to perform functions as follows:

combining, according to the file offset corresponding to each virtual address, file blocks with spacing between file offsets corresponding to the at least one virtual address being smaller than a predetermined number of bits to obtain the prefetch data corresponding to the application program.

According to the device provided in this embodiment, during startup of an application program, by firstly loading at least one file block corresponding to at least one page fault occurred during a history startup process of the application program and then loading code of the application program, the number of page faults occurred during the startup process of the application program because a process cannot be mapped to a valid physical page when accessing a virtual page is greatly reduced since the prefect data includes the file block(s) corresponding to the page fault(s) occurred during the history startup process of the application program. Further, since before the code of the application program is loaded, instead of all file blocks during the initial startup of the application program, only the file block(s) corresponding to page fault(s) is loaded, startup speed and startup efficiency of the application program are improved.

A computer program embodied on a computer-readable medium for the application program startup method according to an embodiment of the present invention, said program comprising:

a step of loading, upon receiving an instruction for starting up an application program, prefetch data corresponding to the application program, wherein the prefetch data comprises at least one file block corresponding to at least one page fault occurred during a history startup process of the application program; and

a step of loading code of the application program to start up the application program.

Preferably, wherein prior to loading, upon receiving an instruction for starting up an application, prefetch data corresponding to the application program, the method further comprises:

analyzing the history startup process of the application program to obtain the prefetch data corresponding to the application program during the history startup process.

Preferably, wherein the analyzing history startup process of the application program to obtain the prefetch data corresponding to the application program during the history startup process specifically comprises:

obtaining at least one mapped file list loaded and the virtual address of the at least one page fault occurred during the history startup process of the application program;

calculating the file offset corresponding to each virtual address according to the at least one mapped file list and the at least one virtual address; and

combining, according to the file offset corresponding to each virtual address, file blocks corresponding to the file offset corresponding to the at least one virtual address to obtain the prefetch data corresponding to the application program.

Preferably, wherein the obtaining at least one mapped file list loaded and the virtual address of the at least one page fault occurred during the history startup process of the application program specifically comprises:

obtaining at least one log file of the application program;

determining a time segment in the at least one log file from a startup time of a user interface process to a foreground window display time as a predetermined startup time segment;

obtaining the mapped file list loaded by a process during the predetermined startup time segment in the at least one log file; and

obtaining the virtual address of the at least one page fault occurred during the predetermined startup time segment.

Preferably, wherein the combining, according to the file offset corresponding to each virtual address, file blocks corresponding to the file offset corresponding to the at least one virtual address to obtain the prefetch data corresponding to the application program specifically comprises:

combining, according to the file offset corresponding to each virtual address, file blocks with spacing between file offsets corresponding to the at least one virtual address being smaller than a predetermined number of bits to obtain the prefetch data corresponding to the application program.

According to the computer-readable medium provided in this embodiment, during startup of an application program, by firstly loading at least one file block corresponding to at least one page fault occurred during a history startup process of the application program and then loading code of the application program, the number of page faults occurred during the startup process of the application program because a process cannot be mapped to a valid physical page when accessing a virtual page is greatly reduced since the prefect data includes the file block(s) corresponding to the page fault(s) occurred during the history startup process of the application program. Further, since before the code of the application program is loaded, instead of all file blocks during the initial startup of the application program, only the file block(s) corresponding to page fault(s) is loaded, startup speed and startup efficiency of the application program are improved.

Described above are merely preferred embodiments of the present invention, but are not intended to limit the present invention. Any modification, equivalent replacement, or improvement made without departing from the spirit and principle of the present invention should fall within the protection scope of the present invention.

1. An application program startup method, comprising:
loading, upon receiving an instruction for starting up an application program, prefetch data corresponding to the application program, wherein the prefetch data comprises at least one file block corresponding to at least one page fault occurred during a history startup process of the application program; and
loading code of the application program to start up the application program;
wherein prior to loading, upon receiving an instruction for starting up an application, prefetch data corresponding to the application program, analyzing the history startup process of the application program to obtain the prefetch data corresponding to the application program during the history startup process; and
wherein the analyzing history start process of the application program to obtain the prefetch data corresponding to the application program during the history startup process specifically comprising:
obtaining at least one mapped file list loaded and the virtual address of the at least one page fault occurred during the history startup process of the application program;
calculating the file offset corresponding to each virtual address according to the at least one mapped file list and the at least one virtual address; and
combining, according to the file offset corresponding to each virtual address, file blocks corresponding to the file offset corresponding to the at least one virtual address to obtain the prefetch data corresponding to the application program.

2. (canceled)

3. (canceled)

4. The method according to claim 1, wherein the obtaining at least one mapped file list loaded and the virtual address of the at least one page fault occurred during the history startup process of the application program specifically comprises:
obtaining at least one log file of the application program;
determining a time segment in the at least one log file from a startup time of a user interface process to a foreground window display time as a predetermined startup time segment;
obtaining the mapped file list loaded by a process during the predetermined startup time segment in the at least one log file; and
obtaining the virtual address of the at least one page fault occurred during the predetermined startup time segment.

5. The method according to claim 1, wherein the combining, according to the file offset corresponding to each virtual address, file blocks corresponding to the file offset corresponding to the at least one virtual address to obtain the prefetch data corresponding to the application program specifically comprises:
combining, according to the file offset corresponding to each virtual address, file blocks with spacing between file offsets corresponding to the at least one virtual address being smaller than a predetermined number of bits to obtain the prefetch data corresponding to the application program.

6. An application program startup apparatus, comprising:
a prefetch data loading module, configured to load, upon receiving an instruction for starting up an application program, prefetch data corresponding to the application program, wherein the prefetch data comprises at least one file block corresponding to at least one page fault occurred during a history startup process of the application program;
a code loading module, configured to load code of the application program to start up the application program; and
a prefetch data obtaining module, configured to analyze the history startup process of the application program to obtain the prefetch data corresponding to the application program during the history startup process, wherein the prefetch data obtaining module comprises:
an obtaining unit, configured to obtain at least one mapped file list loaded and the virtual address of the at least one page fault occurred during the history startup process of the application program;
an offset calculating unit, configured to calculate the file offset corresponding to each virtual address according to the at least one mapped file list and the at least one virtual address; and
a prefetch data obtaining unit, configured to combine, according to the file offset corresponding to each virtual address, file blocks corresponding to the file offset corresponding to the at least one virtual address to obtain the prefetch data corresponding to the application program.

7. (canceled)

8. (canceled)

9. The apparatus according to claim 6, wherein the obtaining unit comprises:
a log obtaining subunit, configured to obtain at least one log file of the application program;
a time segment determining subunit, configured to determine a time segment in the at least one log file from a startup time of a user interface process to a foreground window display time as a predetermined startup time segment;
a mapped file list obtaining subunit, configured to obtain the mapped file list loaded by a process during the predetermined startup time segment in the at least one log file; and
a virtual address obtaining subunit, configured to obtain the virtual address of the at least one page fault occurred during the predetermined startup time segment.

10. The apparatus according to claim 6, wherein the prefetch data obtaining unit is specifically configured to combine, according to the file offset corresponding to each virtual address, file blocks with spacing between file offsets corresponding to the at least one virtual address being smaller than a predetermined number of bits to obtain the prefetch data corresponding to the application program.
